(19) United States
(12) Patent Application Publication
(10) Pub. No.: US 2005/0029477 A1
(43) Pub. Date: Feb. 10, 2005

(54) Remote-actuated valve system

(76) Inventor: Kurt Wolf, Dumont, IA (US)

Correspondence Address: DAVIS, BROWN, KOEHN, SHORS & ROBERTS, P.C.;THE FINANCIAL CENTER, 666 WALNUT STREET, SUITE 2500, DES MOINES, IA, 50309-3993, US

(21) Appl. No.: 10/881,934

(22) Filed: Jun. 30, 2004

Related U.S. Application Data
(60) Provisional application No. 60/483,743, filed on Jun. 30, 2003.

(51) Int. Cl. F16K 31/02

(52) U.S. Cl. 251/129.04

(57) ABSTRACT

A remote-activated valve mechanism for switching a manure agitator-pump apparatus from agitate to full power pump, full power pump to half-power pump, and full or half-power pump to off. The valve mechanism has male and female ends for fitting in a joint between manure piping, a butterfly-style valve, and electric actuator. The electric actuator is powered by a 12-volt power source, and activated by a hand-held remote and remote receiver box programmed to set the valve at open, closed, or partially closed positions.

### BACKGROUND OF THE INVENTION

1. Field of the Art

The present invention relates generally to a valve system for an agitator-pump apparatus which can switch an agitator-pump apparatus from agitation of manure to pumping of manure, and more specifically, to a remote-activated, electric actuated, butterfly valve to switch from agitation of manure to pumping of manure without having to approach the agitator-pump apparatus.

2. Background of the Art

The procedure of storing manure in feedlots and dairy operations is fairly common. Manure is allowed to collect in a pit beneath the animal enclosures, where it is stored for a period of time until the operator is ready to remove the manure. For example, in hog operations, the manure is usually stored during the winter months and then removed and spread on crop fields prior to plowing in the spring.

During storage in the pits, the manure is substantially in liquid form, but solid matter tends to either settle to the bottom or float to the surface. To pump the manure out of the pit, it must be of a certain uniform consistency, which requires agitation of the manure in the pit prior to pumping. To facilitate this, agitator-pump apparatus have been developed that perform the dual role of agitating the manure into a fairly uniform slurry, and then pumping the manure up and out of the storage pit. Agitation is usually accomplished by drawing the manure into the apparatus through one opening and then expelling it back out into the pits through another opening. To switch from the agitation function to the pumping function, an assortment of different types of valves are used to direct the flow of manure up and out of the pit and into storage tanks, rather than circulating the manure back into the pit. The agitator-pump apparatus is usually connected to, and powered by a tractor motor.

The tanks used to collect this expelled manure are usually attached to another tractor or storage unit, which, depending on the portion of the confinement facility that is being pumped, may be located some distance away from the agitator-pump apparatus. This requires the operator of the agitator-pump apparatus to start the apparatus on agitate mode and allow the manure to agitate for a substantial period of time. When ready to fill the manure tank, the pump operator must position the manure tank in the appropriate position, then walk the entire distance back to the pump mechanism at the pit, turn off the tractor powering the agitator, switch the hydraulic valve from agitate to pump, and restart the tractor. Then the operator must return to the tank tractor to supervise the filling of the tank. The operator must then estimate how full the tank must be to allow him time to walk back to the pump and switch the hydraulics on the pump valve again to stop the flow of manure. This time delay can result in under or overflow of the manure tank, and foaming of the manure due to high flow pressure while the tank is close to full.

Furthermore, most pumps use a hydraulic pinch valve closure mechanism, which requires the tractor to be at low power for the switch from agitate to pump, and the fast open and closure of this valve often causes the hoses of the pump to blow off, and the pump and platform to buck.

The present invention allows for the operator to remain at the manure tank during the switch from agitate to pump and during the entire pumping process through use of a remote controlled valve mechanism. With most brands of pumps, the valve even eliminates the need to turn the tractor powering the agitator-pump apparatus to off or to low power when switching the agitator-pump apparatus from agitate to pump. The remote valve further includes a button to allow for an intermediate level of manure flow, which can slow the pumping of manure at the end of the filling process to reduce foaming and overflow. Due to the fact the operator never has to leave the tractor, the tank can be filled to precisely its capacity, with no danger of under-filling or overflowing the tank. Additionally, the optional rotating red light indicator notifies the operator when the valve is fully closed, even when the operator is located a great distance away from the mechanism.

The use of a butterfly valve in the present invention also allows for gradual opening and closing of the valve mechanism, which eliminates the problem of bucking of the pump and platform, and blowing of the hose connections.

### SUMMARY OF THE INVENTION

The present invention is a remote operated butterfly-style valve system for a pump-agitator apparatus comprising a hand-held remote signaler, a remote reception box powered by a 12-volt power source, a valve actuator attached to the reception box for rotation of the valve plate, and male and female connector ends.

The valve body consists of a stock, wafer-style valve. The circular valve disk is mounted on a center axis running through the diameter of the disk. The center axis runs though the long axis of the valve body, such that the disk surface can be rotated around the center axis. In the fully open configuration of the valve, the disk is located in a plane perpendicular to the plane of the valve body to allow fluid to pass through the valve body. In the fully closed configuration of the valve, the disk is in the same plane as, and completely seals the opening in the valve body, thereby blocking the flow of fluid through the valve body. An electric valve actuator rotates the center axis of the valve to open and close the valve.

The valve is inserted into the pump apparatus at a joint along the manure pipe using male and female ends, rigidly affixed to either side of the valve body. The exact shape and configuration of the male and female ends depends on the brand and style of the agitator-pump apparatus. The female end of the valve contains a clamp to secure it to the male end of the manure pipe, and the female end of the manure pipe contains a clamp to secure it to the male end of the valve. The valve may be installed either on top of the agitator-pump apparatus, or along a horizontal span of manure pipe.

The hand-held remote box consists of a rectangular box, antenna, and three push buttons. The three buttons correspond to the three positions of the valve: open, closed, and partially closed. When the appropriate button is depressed on the hand-held remote box, a signal is sent to the remote receiver attached to the valve actuator, which rotates the valve axis to the appropriate position to open, close, or partially close the valve. The rotating indicator light activates when the valve is filly closed to indicate to the operator that the flow of manure has stopped.

These and other elements of the present invention will become apparent to one skilled in the art upon presentation of the accompanying drawings, description, and claims.

### BRIEF DESCRIPTION OF THE DRAWINGS

FIG. 1 is a perspective view of the valve body, axis, and plate.

FIG. 2(a) is a perspective view of the hand-held remote box, indicator light, and remote receiver.

FIG. 2(b) is a perspective view of the valve unit.

FIG. 3 is a perspective view of the valve unit and alternative male and female unit.

FIG. 4 is a perspective view of the valve unit as attached to the joint in the manure pipe.

FIG. 5 is an alternate perspective view of the valve unit as attached to the joint in the manure pipe.

FIG. 6 is a perspective view of the valve unit in FIG. 5 in relation to the agitator-pump apparatus and attached tractor.

FIG. 7 is a perspective view of the hog confinement facility in relation to pump apparatus and attached tractor.

### DETAILED DESCRIPTION OF THE INVENTION

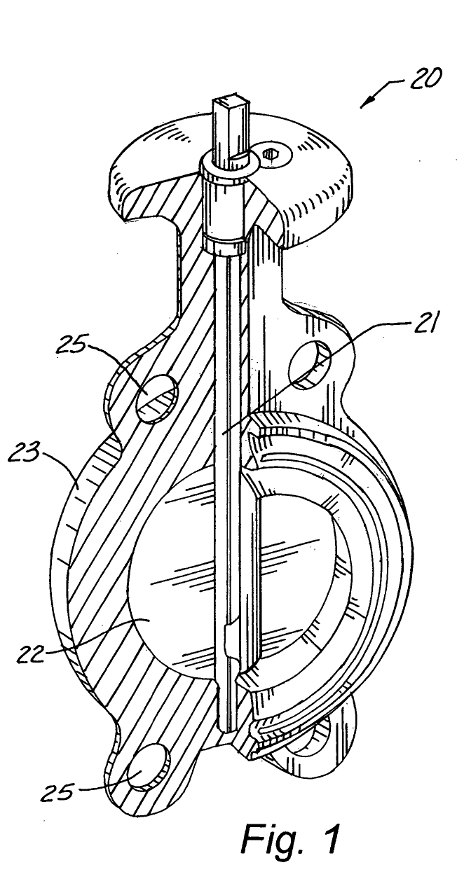

In reference to FIG. 1, the valve unit 20 comprises a wafer-style valve with a flat valve disk 22 rigidly affixed to a center valve axis 21. The valve axis 21 runs down the long axis of the valve body 23. The valve disk 22 rotates about the valve axis 21 such that, when positioned perpendicular to the plane of the valve body, fluid passes through the opening in the valve body 23. When the valve disk 22 is positioned such that it is parallel to, and fits into the opening in the valve body 23, it seals the opening closed such that liquid cannot pass through the valve body. Boltings 25 extend from the outer surfaces of the valve body 23. The valve neck 24 extends from the upper portion of the valve body 23 and surrounds the extension of the valve axis 21.

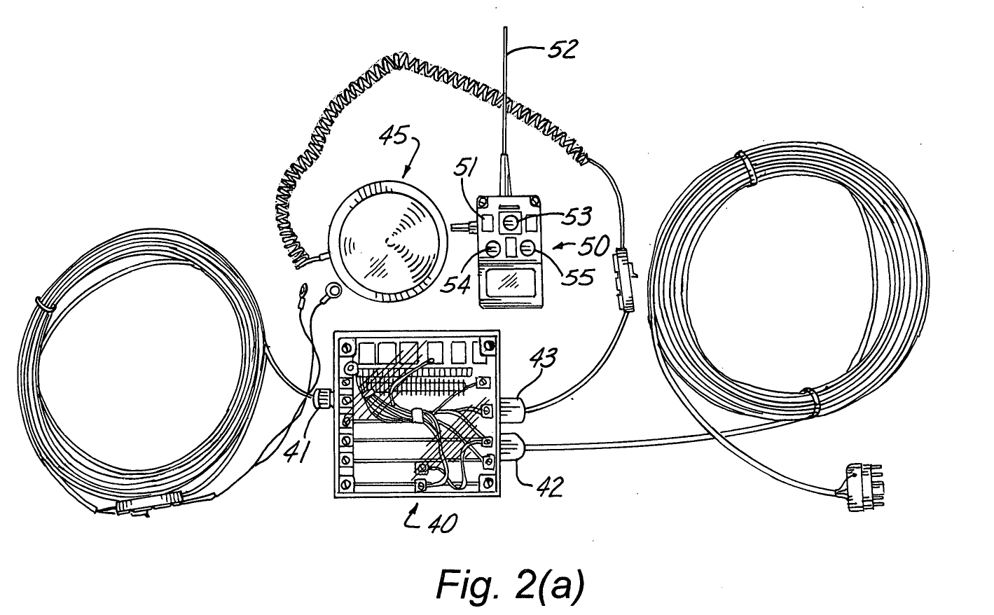

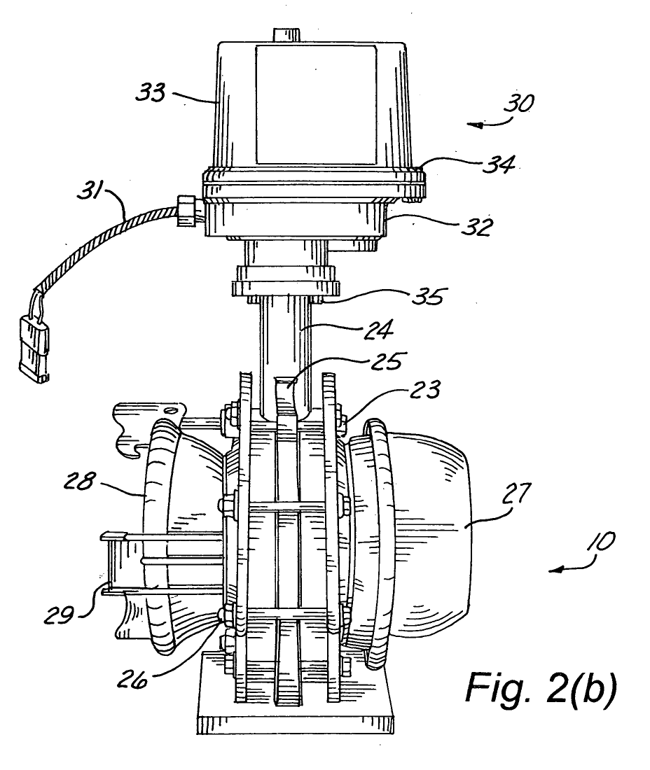

FIG. 2(a) shows the remote receiver box 40, which is a programmable box fitted with an input receptor cord 41 that supplies 12-volts of power. On the opposite side of the box is an output power cord 42 that connects to the valve actuator 30. The receiver box 40 also contains an optional power cord 43 which extends to the indicator light 45.

The hand-held remote box 50 comprises a rectangular box 51, to which are affixed three buttons: the close button 53, the open button 55, and the part-close button 54. An antenna 52 extends from the top portion of the rectangular box that is equipped to send radio frequency signals to the remote receiver box 40.

FIG. 2(b) shows the valve actuator 30 as attached to the valve neck 24 using a plurality of fasteners 35. The actuator power cord 31 extends from the lower casing 32 of the actuator. The upper casing 33 is attached to the lower casing 32 using a plurality of fasteners 34.

The male 27 and female 28 ends are rigidly affixed to either flat surface of the valve body 23 using a plurality of fasteners 26. Some of the fasteners 26 pass through the boltings 25 to ensure a tight fit. The male end 27 and female end 28 may also be affixed by welding the end to the valve body to further prevent leakage.

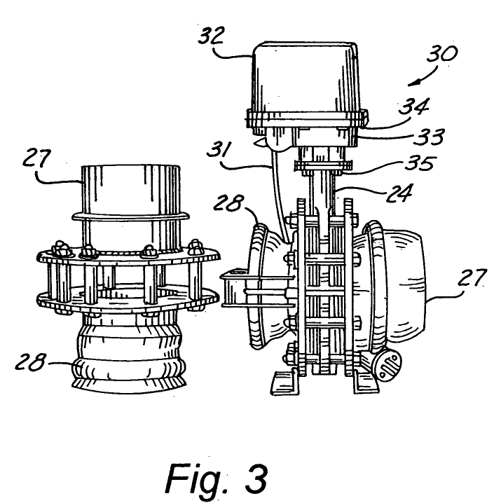

The female end 28 further comprises a clamp unit 29, which affixes the female end to the adjacent pipe by placing the clamp body onto the lip of the adjacent pipe and locking the clamp into place. FIG. 3 shows an alternate structure of the male end 27 and female end 28 for use with a different brand of agitator-pump apparatus.

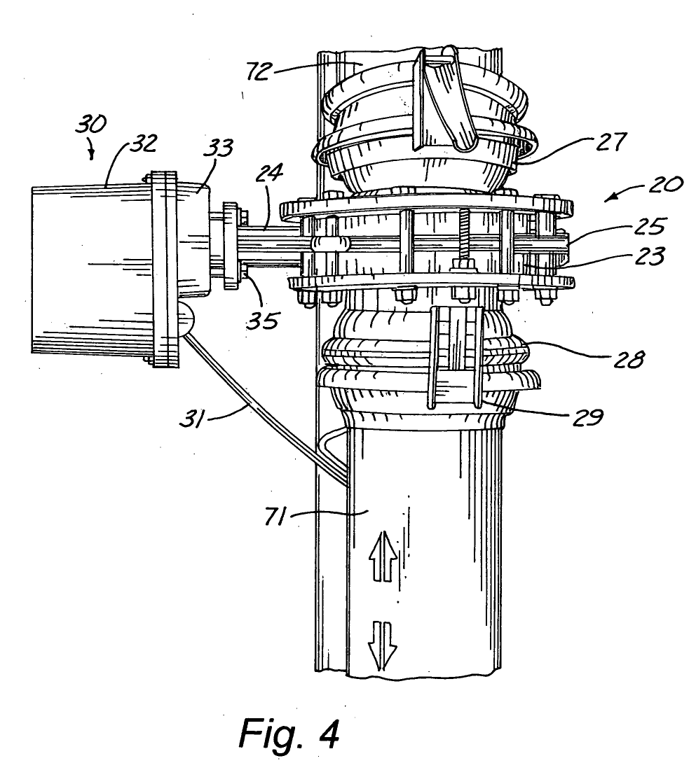

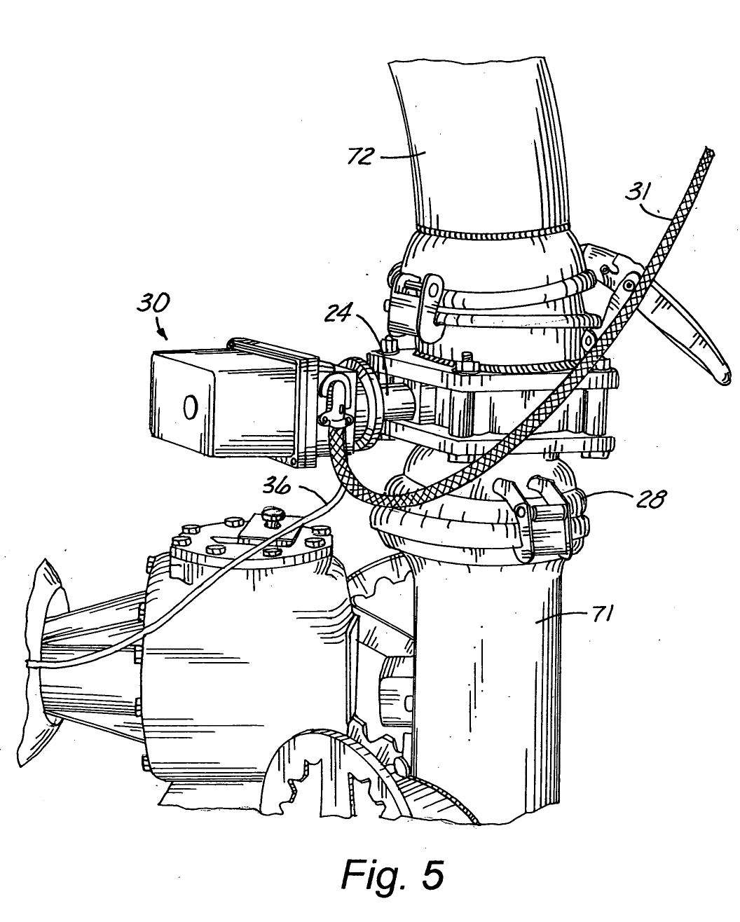

FIGS. 4-6 show attachment of the valve unit to an agitator-pump apparatus. The female end 28 of the valve unit fits over the male end of the input pipe 71 of the agitator-pump apparatus. The female end clamp 29 is clamped onto the lip of the input pipe 71. The male end 27 of the valve unit is inserted into the female end of the output pipe 72 of the agitator-pump apparatus.

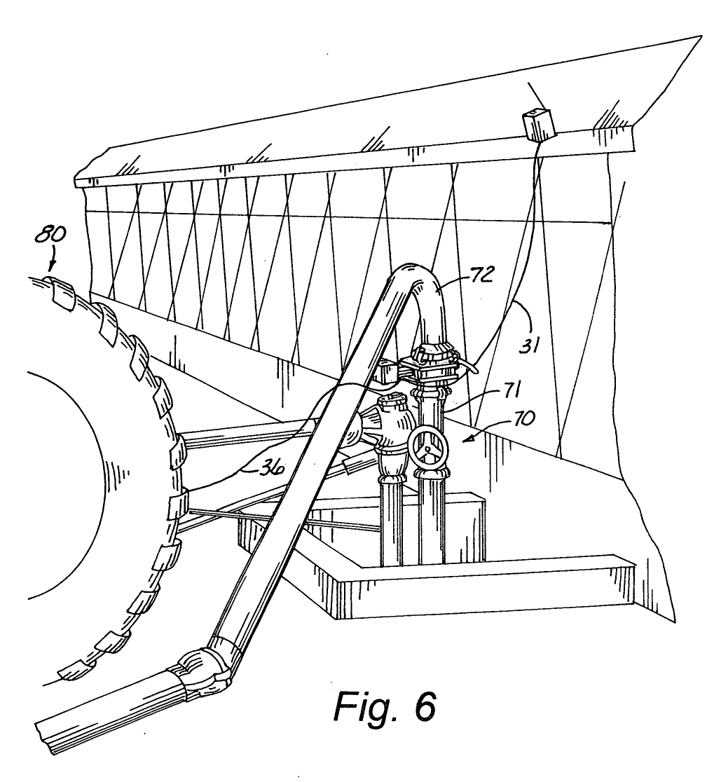

FIG. 6 also shows the connection of the valve apparatus to power sources. The valve actuator 30 is powered by a 12-volt current supplied by the power cord 31. The valve actuator 30 is also connected to the remote receiver box 40 located on the agitator-pump tractor 80 by the output cord 43.

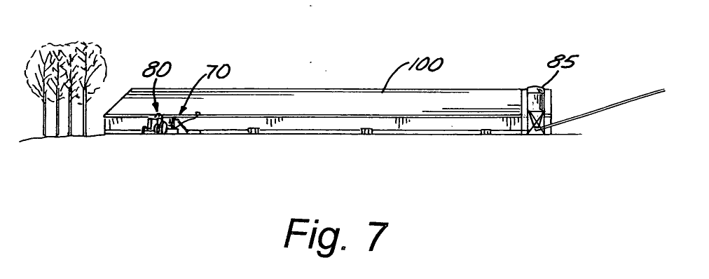

FIG. 7 shows the agitator-pump apparatus 70 and accompanying tractor 80, located a considerable distance away from the manure tank that is being filled 85 at the other end of the enclosure building 100.

To use the valve mechanism, the operator must first turn on the agitator-pump apparatus 70 to the agitate position. Once the manure is of a uniform slurry suitable for pumping, the operator places the manure tank in position. The operator then pushes the open button 55 on the hand-held remote. This sends a signal to the remote receiving box 40, which in turn signals the valve actuator 30 to rotate the valve axis 21 to position the valve plate 22 perpendicular to the plane of the valve body 23. This allows the manure to flow up and out of the storage pit and through the valve apparatus to the manure tank 85. The operator then observes the filling of the manure tank. When almost full, the operator presses the partially-close button 54, which signals the valve actuator 30 to rotate to an approximate 45-degree angle to the plane of the valve body 23 to slow the flow of manure through the valve. When the tank is full, the operator presses the close button 23 on the hand held remote to rotate the valve axis 21 to position the valve plate 22 in a fully closed position, which stops the flow of manure out of the pit.

Although the invention has been described with respect to a preferred embodiment thereof, it is to be also understood that it is not to be so limited since changes and modifications can be made therein which are within the full intended scope of this invention as defined by the appended claims. This application claims priority to U.S. patent application Ser. No. 60/483,743, filed Jun. 30, 2003.

1. A valve mechanism for an agitator-pump apparatus which remotely switches the operation from agitate to pump through use of a valve, comprising:
(a) a hand-held remote sending apparatus;
(b) a remote reception box;
(c) a valve unit comprising a butterfly valve, valve body, and electric actuator;
(d) an input end connection to the valve unit; and
(e) an output end connection to the valve unit.

2. The valve mechanism of claim 1, wherein the hand-held remote sending apparatus comprises three switches corresponding to the fully open, fully closed, and partially closed positions of the valve unit, and an antenna.

3. The valve mechanism of claim 1, wherein the remote reception box is powered by a 12-volt power source.

4. The valve mechanism of claim 1, wherein the remote reception box is connected to the electric actuator, and programmed to send signals to the electric actuator in response to the operation of the switches on the hand-held remote sending apparatus.

5. The valve mechanism of claim 1, wherein the electric actuator rotates the valve between a fully open position, where the valve plate is perpendicular to the valve opening; a fully closed position, where the valve plate is parallel to, and completely seals the valve opening, and a partially closed position, where the valve plate is positioned at an angle between parallel and perpendicular to the valve body.

6. The valve mechanism of claim 1, wherein the input end of the valve unit is rigidly affixed to one opening on the planar surface of the butterfly valve, and the output end unit is rigidly affixed to the opposing planar surface of the butterfly valve.

7. The valve mechanism of claim 1, wherein one or both ends of the valve unit comprises male connection comprising a generally cone-shaped tube for fitting inside a female end connector of an agitator-pump apparatus pipe.

8. The valve mechanism of claim 1, wherein one or both ends end unit of the valve comprises a female connection comprising a generally dome-shaped tube for fitting over and encompassing a male end connector of an agitator-pump apparatus pipe.

9. The valve mechanism of claim 1, wherein the remote reception box further comprsises an indicator light that activates when the valve is in the fully closed position.
